(19) United States
(12) Patent Application Publication
(10) Pub. No.: US 2026/0107947 A1
(43) Pub. Date: Apr. 23, 2026

(54) SILVER-INFUSED ANTIMICROBIAL FABRIC

(71) Applicant: Yu Jeong Chung, Seoul (KR)

(72) Inventor: Yu Jeong Chung, Seoul (KR)

(21) Appl. No.: 19/324,587

(22) Filed: Sep. 10, 2025

(30) Foreign Application Priority Data
Oct. 22, 2024 (KR) 10-2024-0145114

(51) Int. Cl. A01N 59/16; D03D 15/275; D03D 15/283; D03D 15/47; D03D 15/527

(52) U.S. Cl. CPC A01N 59/16; D03D 15/275; D03D 15/283; D03D 15/47; D03D 15/527; D10B 2101/12; D10B 2321/022; D10B 2331/04; D10B 2401/021; D10B 2401/022; D10B 2401/13; D10B 2501/04

(57) ABSTRACT

Provided is a silver-infused antimicrobial fabric for apparel used in contact with human skin including a skin-contact layer formed on a lower surface that contacts the skin, and a surface layer bonded onto the skin-contact layer, wherein the skin-contact layer is woven from hydrophobic yarn, wherein the surface layer is woven from hydrophilic yarn, wherein the skin-contact layer and the surface layer are joined by a knitted structure, wherein the skin-contact layer is woven from polypropylene yarn, wherein the surface layer is woven from a yarn spun from a blend of polyester and graphene, wherein the yarn constituting the surface layer has a hexagonal cross-sectional structure.

### CROSS-REFERENCE TO RELATED APPLICATION

This application claims priority of Korean Patent Application No. 10-2024-0145114, filed on Oct. 22, 2024, in the KIPO (Korean Intellectual Property Office), the disclosure of which is incorporated herein entirely by reference.

### BACKGROUND OF INVENTION

### Technical Field

The present invention relates to a silver-infused antimicrobial fabric. More specifically, it relates to a functional silver-infused antimicrobial fabric that contains silver and has a double-layer structure, wherein one layer in contact with the skin is hydrophobic to maintain a dry state, and the other layer is hydrophilic to absorb and then evaporate moisture, thereby inhibiting the growth of microorganisms and providing a sterilizing function on the layer in contact with the skin.

### Description of the Related Art

Recently, with growing interest in hygiene and health, the demand for various products with antimicrobial functions has been increasing. In particular, there is a need for an antimicrobial function in textile products that are frequently contacted in daily life to inhibit the proliferation of microorganisms and maintain a hygienic environment. Such antimicrobial textile products can be used in various fields such as apparel, bedding, and medical textiles, and play an important role in preventing infections or odor caused by microorganisms.

Silver has long been recognized for its excellent antimicrobial effects. Silver ions function to disrupt the growth of microorganisms by destroying their protein structure or inhibiting enzyme reactions. Due to these antimicrobial properties of silver, silver-containing textile products are widely used in various fields and show high effectiveness, especially in products that are in contact with the skin for extended periods.

However, conventional antimicrobial fabrics were manufactured by simply including an antimicrobial substance. While these have an antimicrobial effect, other issues such as moisture absorbency of the fabric and comfort upon skin contact have not been sufficiently improved. Furthermore, structural innovation of the fabric is needed to maintain a continuous antimicrobial effect.

To solve these problems, a technology such as that in Korean Registered Patent No. 10-1908434 has been proposed. However, the problem with this design is that the hydrophilic part had a low moisture capacity, leading to a problem where it could no longer absorb moisture when a large amount of moisture was generated from the skin. Additionally, there was a problem that it could not inhibit microbial growth that could occur in the hydrophilic part. It would therefore be beneficial to have a fabric which avoids these and other issues of existing fabrics.

### SUMMARY OF THE INVENTION

An object of the present invention is to provide a functional fabric that contains silver and has a double-layer structure, wherein one layer in contact with the skin is hydrophobic to maintain a dry state, and the other layer is hydrophilic to absorb and then evaporate moisture, thereby inhibiting the growth of microorganisms and providing a sterilizing function on the layer in contact with the skin, and has a high moisture capacity in the hydrophilic part to absorb a large amount of moisture generated from the skin, while ensuring that both the hydrophobic and hydrophilic parts have an antimicrobial function.

The objects of the present invention are not limited to the aforementioned objects, and other unstated objects will be clearly understood by those of ordinary skill in the art to which the present invention pertains from the following description.

To achieve the above object, a fabric for apparel used in contact with human skin according to an embodiment of the present invention includes a skin-contact layer formed on the lower surface that contacts the skin and a surface layer bonded onto the skin-contact layer, wherein the skin-contact layer is woven from hydrophobic yarn, the surface layer is woven from hydrophilic yarn, the skin-contact layer and the surface layer are joined by a knitted structure, the skin-contact layer is woven from polypropylene yarn, the surface layer is woven from a yarn spun from a blend of polyester and graphene, and a part of the skin-contact layer includes a silver-containing yarn.

The silver-containing yarn in the skin-contact layer may be a yarn of pure silver plated on nylon yarn and may be formed in a linear shape and repeated at regular intervals. Additionally, the silver-containing yarn may be included in both the surface layer and the skin-contact layer. Furthermore, the yarn constituting the surface layer may have a hexagonal or polygonal cross-sectional structure.

The silver-infused antimicrobial fabric according to the present invention can be maintained in a dry state by the hydrophobic skin-contact layer to maintain an antimicrobial state. The fabric is particularly formed of polypropylene yarn to maintain its shape without deformation, thereby maintaining the gap between yarns for air permeability. This design provides resistance to bacteria and allows moisture such as sweat generated from the skin to be absorbed by the hydrophilic surface layer and easily evaporate from the surface. The result is a material with excellent moisture absorption, drying capability, far-infrared radiation protection, UV protection, anti-static properties, and antimicrobial power due to the graphene forming the surface layer.

Furthermore, by making the cross-sectional shape of the yarn of the surface layer hexagonal or polygonal, the air passages formed between the yarns are larger and more uniform, resulting in enhanced breathability.

In addition, the antimicrobial capability can be enhanced by the silver-containing yarn, which can be formed by plating pure silver onto nylon as a coating. Because nylon and pure silver have good bonding strength, the pure silver is retained in the fabric during washing or use.

The effects of the present invention are not limited to the aforementioned effects, and other unstated effects will be clearly understood by those of ordinary skill in the art to which the present invention pertains from the following description.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a cross-sectional view of an embodiment of the present invention.

FIG. 2 is an enlarged view of a part of an embodiment of the present invention.

FIG. 3 is an exploded view of an embodiment of the present invention.

FIG. 4 is an enlarged view of a part of an embodiment of the present invention.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

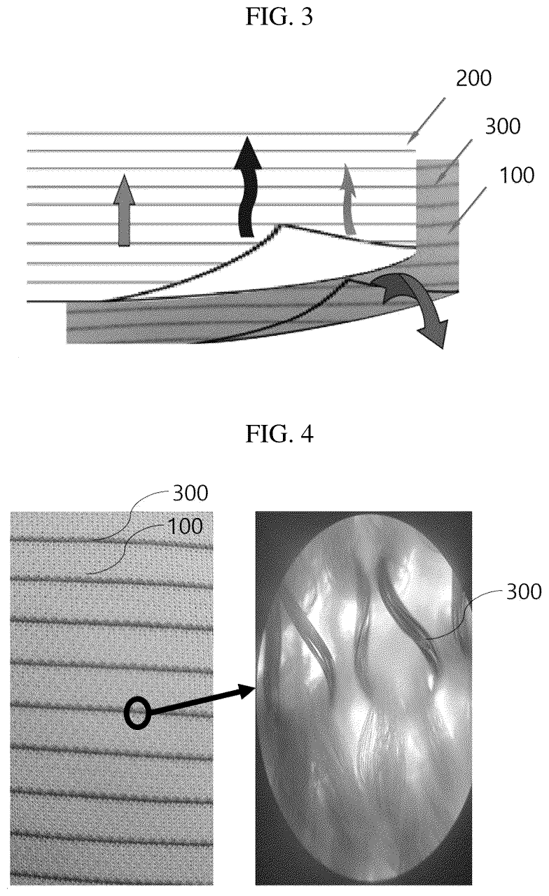

As shown in FIGS. 1 and 3, an embodiment of the present invention includes a skin-contact layer 100, a surface layer 200, and a silver-containing yarn 300.

The embodiment of the present invention is a fabric for apparel used in contact with human skin and can be used for various types of apparel that come into contact with the skin, such as underwear, shirts, and gloves.

The skin-contact layer 100 is the part formed on the lower surface that contacts the skin, is woven from a hydrophobic yarn, such as polypropylene yarn, and a part of it includes the silver-containing yarn 300.

TABLE 1
Specific Gravity Comparison Table of Yarns

| Fiber | Specific Gravity |
|---|---|
| Cotton | 1.54 |
| Rayon | 1.52 |
| Polynosic | 1.52 |
| Linen | 1.5 |
| Silk | 1.39 |
| Polyester | 1.38 |
| Wool | 1.32 |
| Acetate | 1.32 |
| Polyurethane | 1.2 |
| Acrylic | 1.15 |
| Nylon | 1.14 |
| Polypropylene | 0.91 |

As seen in Table 1 above, polypropylene has a low specific gravity and is designed to not hold moisture but to discharge it. The skin-contact layer may be woven from a hydrophobic yarn such as polypropylene, so that moisture is discharged to the hydrophilic surface layer.

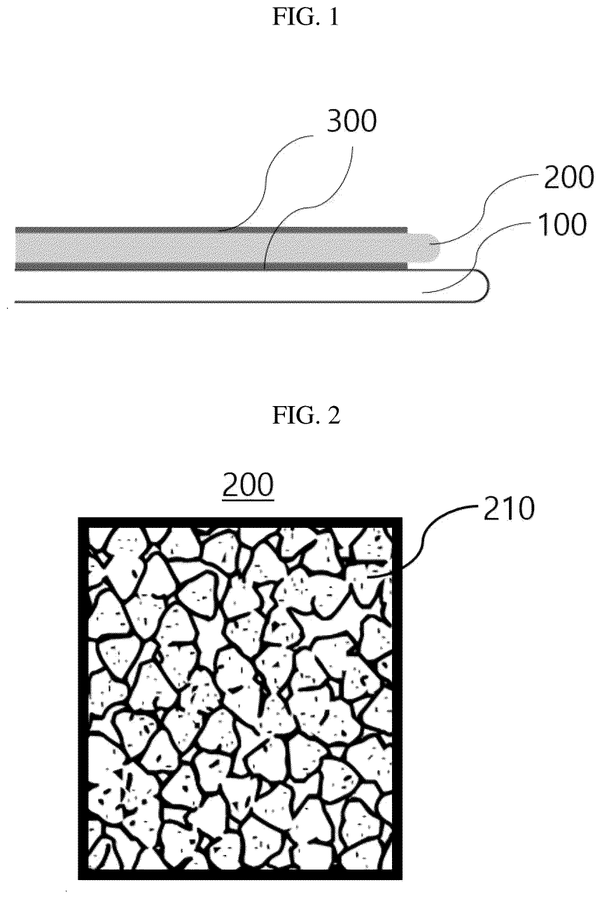

The surface layer 200 woven from hydrophilic yarn and is bonded onto the skin-contact layer 100. The skin-contact layer and the surface layer may be joined by a knitted structure. The surface layer may be woven from a yarn spun from a blend of polyester and graphene. The yarn 210 may have a hexagonal or polygonal cross-sectional structure as shown in FIG. 2. In particular, the yarn may contain graphene and may have a hexagonal shape, resulting in high breathability and absorbency because pores are formed uniformly and are larger compared to the cylindrical cross-section of general polyester.

The silver-containing yarn in the skin-contact layer may be a yarn of pure silver plated on nylon yarn. The silver-containing yarn 300 may be formed in a linear shape and repeated at regular intervals as shown in FIG. 4. The layers may be formed in a manner where the silver-containing yarn is woven together with the other yarns of the skin-contact layer.

TABLE 2

| | |
|---|---|
| | Test Result |
| Test Item | Sample 1 |

Antimicrobial rate (%) KS K 0693:2022
Bacteriostatic reduction rate

| | |
|---|---|
| Test strain \textcircled{1} | 99.9 |
| Test strain \textcircled{2} | >99.9 |
| Test strain \textcircled{3} | 99.4 |
| Test strain \textcircled{4} | 99.9 |

* Note)
1. Test strains:
Test strain \textcircled{1}: Staphylococcus aureus ATCC 6538
Test strain \textcircled{2}: Escherichia coli ATCC 25922
Test strain \textcircled{3}: Candida albicans ATCC 10231
Test strain \textcircled{4}: Staphylococcus epidermidis ATCC 14990
2. Concentration of inoculum:
Test strain \textcircled{1}: 0.8 × 10⁵ CFU/mL
Test strain \textcircled{2}: 0.7 × 10⁵ CFU/mL
Test strain \textcircled{3}: 0.9 × 10⁵ CFU/mL
Test strain \textcircled{4}: 0.9 × 10⁵ CFU/mL
3. Control swatch: Standard cotton
4. Nonionic surfactant: Tween 80, 0.05% added to the inoculum

Table 2 above shows the antimicrobial activity test results for an embodiment of the present invention using four bacterial strains, confirming that the reduction rate for major bacterial strains is from 99.4% to 99.9%, which indicates that the antimicrobial function of the fabric of the embodiment of the present invention is excellent.

The embodiments of the present invention disclosed in this specification and drawings are presented as specific examples merely to easily explain the technical content of the present invention and to aid in the understanding of the present invention and are not intended to limit the scope of the present invention. It is apparent to those of ordinary skill in the art to which the present invention pertains that other modified examples based on the technical idea of the present invention can be implemented in addition to the embodiments disclosed herein.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A silver-infused antimicrobial fabric for apparel used in contact with human skin, comprising:
a skin-contact layer formed on a lower surface that contacts the skin; and
a surface layer bonded onto the skin-contact layer,
wherein the skin-contact layer is woven from hydrophobic yarn,
wherein the surface layer is woven from hydrophilic yarn,
wherein the skin-contact layer and the surface layer are joined by a knitted structure,
wherein the skin-contact layer is woven from polypropylene yarn,
wherein the surface layer is woven from a yarn spun from a blend of polyester and graphene,
wherein the yarn constituting the surface layer has a hexagonal cross-sectional structure,
wherein a part of the skin-contact layer includes a silver-containing yarn.

2. The silver-infused antimicrobial fabric of claim 1, wherein the silver-containing yarn in the skin-contact layer is a yarn of pure silver plated on nylon yarn.

3. The silver-infused antimicrobial fabric of claim 1, wherein the silver-containing yarn in the skin-contact layer is formed in a linear shape and is repeated at regular intervals.
